(19) United States
(12) Patent Application Publication
(10) Pub. No.: US 2008/0295556 A1
(43) Pub. Date: Dec. 4, 2008

(54) Controlled Metal Foil Production Process, Apparatus for Performing the Production Process, and Metal Foil

(75) Inventors: Jan Hodgson, Troisdorf (DE); Gunter Hoster, Overath (DE)

Correspondence Address: LERNER GREENBERG STEMER LLP, P O BOX 2480, HOLLYWOOD, FL, 33022-2480, US

(73) Assignee: EMITEC GESELLSCHAFT FUR EMISSIONSTECHNOLOGIE MBH, Lohmar (DE)

(21) Appl. No.: 11/939,108

(22) Filed: Nov. 13, 2007

Related U.S. Application Data
(63) Continuation of application No. PCT/EP2006/004481, filed on May 12, 2006.

(30) Foreign Application Priority Data
May 13, 2005 (DE) DE102005022238.2

(51) Int. Cl. B21D 33/00; B32B 3/12

(52) U.S. Cl. 72/11.1; 72/379.6; 72/31.07; 72/203; 428/98; 428/116

(57) ABSTRACT

A process produces structures which are superimposed on one another in a metal foil section. The process includes producing a primary structure using a first tool, and transferring the metal foil section to a second tool, the second tool having at least one shaping profiled roller which is responsible for transferring the metal foil section. A secondary structure is produced using the second tool. A spatial position of the primary structure and the secondary structure is determined in at least one subregion of the metal foil section. An incorrect position is detected and an operating parameter of the at least one profiled roller is adapted in dependence on the detected incorrect position. An apparatus is suitable for this process and produces metal foils which are suitable for the production of catalyst support bodies that can be used in exhaust systems of internal combustion engines.

### CROSS-REFERENCE TO RELATED APPLICATIONS

This is a continuing application, under 35 U.S.C. § 120, of copending international application No. PCT/EP2006/004481, filed May 12, 2006, which designated the United States; this application also claims the priority, under 35 U.S.C. § 119, of German patent application No. DE 10 2005 022 238.2, filed May 13, 2005; the prior applications are herewith incorporated by reference in their entirety.

### BACKGROUND OF THE INVENTION

### Field of the Invention

The invention relates to a process and an apparatus for producing structures which are superimposed on one another in a metal foil section. Metal foil sections of this type are preferably used to construct honeycomb bodies that are used, for example, as exhaust-gas treatment components in exhaust systems of internal combustion engines.

For the exhaust-gas treatment of mobile internal combustion engines, such as for example spark-ignition and diesel engines, it is known to dispose at least one exhaust-gas treatment component, which provides a relatively large surface area (such as what is known as a honeycomb body), in the exhaust pipe. These components are if appropriate provided with an application-specific (e.g. adsorbing, catalytically active and/or other) coating, intimate contact with the exhaust gas flowing past being realized on account of the large surface area of the component. Examples of these components include filter elements for filtering out particulates contained in the exhaust gas, adsorbers for storing pollutants (e.g. NOₓ) contained in the exhaust gas for at least a limited time, catalytic converters (e.g. 3-way catalyst, oxidation catalyst, reduction catalyst, etc.), diffusers for influencing the flow of and/or swirling up the exhaust gas flowing through or also heating elements which heat the exhaust gas to a desired temperature in particular after an internal combustion engine cold start. The following support substrates have fundamentally proven suitable for the conditions of use in the exhaust system of an automobile: ceramic honeycomb bodies, extruded honeycomb bodies and honeycomb bodies made from metal foils. In view of the fact that these support substrates always need to be adapted to their corresponding function, high-temperature-resistant and corrosion-resistant metal foils represent especially suitable starting materials for their production.

It is known to produce honeycomb bodies using a plurality of at least partially structured metal sheets, which are then introduced into a housing and thereby form a support body which can be provided with one or more of the above mentioned coatings. The at least partially structured metal sheets are disposed in such a way as to form passages disposed substantially parallel to one another. To ensure this, some of the metal sheets are provided with a structure, for example a type of corrugation structure, sawtooth structure, square-wave structure, delta-wave structure, omega structure or the like.

Furthermore, it is known to introduce a second structure into sheet-metal foils of this type, the second structure being intended in particular to prevent a laminar flow, with which gas exchange between regions of the exhaust-gas part-stream located in the center of a passage of this type and the, for example, catalytically active passage wall regions does not take place to a sufficient extent, from forming immediately after the exhaust gas has entered the honeycomb body. The second structure or microstructure provides flow-facing surfaces which are responsible for swirling up the exhaust-gas part-streams in the interior of a passage of this type. This leads to intensive mixing of the exhaust-gas part-streams themselves, thereby ensuring intimate contact between the pollutants contained in the exhaust gas and the passage wall.

Furthermore, it is possible to use second structures of this type to form flow ducts running transversely to the passage, allowing gas exchange between exhaust-gas part-streams in adjacent passages. For this reason, it is known to use microstructures which contain, for example, guide surfaces, studs, projections, vanes, tabs, holes or the like. In this respect, there is a very considerable range of variation when producing metallic honeycomb bodies of this type compared to honeycomb bodies made from ceramic material, since such complex passage walls cannot be realized, or can only be realized with a particularly high level of technical outlay, using ceramic material.

These metal sheets provided with structures are then stacked (if appropriate alternately with smooth interlayers between them), intertwined and inserted into a housing, leading to the formation of a honeycomb body which has passages that are substantially parallel to one another.

Furthermore, in the context of exhaust-gas treatment it is of particular interest for pollutants contained in the exhaust gas to be converted virtually immediately after the internal combustion engine has started up. This should take place with a particularly high efficiency in accordance with statutory stipulations and guidelines. For this reason, ever thinner metal sheets have been used in the past. These thinner sheets provide a very low area-specific heat capacity, i.e. relatively little heat is withdrawn from the exhaust gas flowing past, or the temperature of the metal sheets themselves rises relatively quickly. This is important because the catalytically active coatings which are currently used in the exhaust system only start to convert the pollutants above a certain light-off temperature, which is approximately 230° C. to 270° C. With a view to converting these pollutants with at least a 98% efficiency after just a few seconds, metal sheets with a thickness of, for example, less than 0.1 mm, in particular even less than 0.05 mm, are used.

However, the above-mentioned objectives give rise to a number of manufacturing technology and application-related problems. For example, it should be noted that under certain circumstances the targeted setting of an exhaust gas flow profile in the honeycomb body requires precise alignment of the microstructures in the passages. Furthermore, it should be borne in mind that metal foils of this type are connected to one another by joining techniques, in particular are soldered together, brazed (if appropriate under a vacuum) and/or are welded to one another. However, this presupposes the presence of defined contact regions between the metal foils. This in turn results in that it is necessary to ensure that the structures which are superimposed on one another are aligned as accurately as possible. Hitherto, it has not been possible to ensure this with a sufficient level of accuracy. On account of external influences involved in the production of the structures, such as for example vibrations excited in the metal foils, deviations occur in the drawing and/or forming properties of the metal foil. Manufacturing inaccuracies or tolerances within the tools (such as for example true-running errors, positioning errors, contour errors in rolling teeth, etc.) lead to undesirable deviations in the positions of the structures with respect to one another which periodically fluctuate. Moreover, inhomogeneities in the material used for the metal foils can lead to further deviations in the structures with respect to one another.

### SUMMARY OF THE INVENTION

It is accordingly an object of the invention to provide a controlled metal foil production process, apparatus for performing the production process, and metal foil which overcome the above-mentioned disadvantages of the prior art devices and methods of this general type. In particular, it is intended to provide a process for producing multiply structured metal foils of this type which ensures that the structures which are superimposed on one another are aligned as accurately as possible with respect to one another. The process is also to satisfy the demands of series production for metal foils of this type and to represent a time-saving and cost-saving route. Furthermore, it is intended to provide an apparatus for producing metal foils of this type. The metal foils produced by the process and/or the apparatus are to have a particularly accurate alignment of the structures which are superimposed on one another and are to be used in particular to produce durable honeycomb bodies which can be used in the exhaust system of internal combustion engines.

The invention proposes a metal foil section produced by the process and/or the apparatus and a honeycomb body produced therefrom. The features listed individually in the claims can be combined with one another in any technically appropriate way and can be supplemented by explanatory statements from the description, thereby demonstrating further variant embodiments of the invention.

The process according to the invention for producing structures which are superimposed on one another in a metal foil section includes at least the following steps: producing a primary structure using a first tool and transferring the metal foil section to a second tool. The second tool has at least one shaping profiled roller which is responsible for transferring the metal foil section. A secondary structure is produced with the second tool. A spatial position of the primary structure and the secondary structure is determined in at least one subregion of the metal foil section. An incorrect position is determined and an operating parameter of the at least one profiled roller is adapted.

It is customary for structures of this type to be produced in a continuous process (or with a frequency of greater than 1 advancing step per second), with the metal foil being unrolled from a coil and fed to the tools. Therefore, the process outlined here considers a metal foil section which is deformed. Accordingly, the metal foil section is initially smooth and is fed to the first tool to produce a primary structure. The primary structure is in this case preferably a microstructure, i.e. for example an embossed or stamped formation, which extends only over a small region of the metal foil section and is intended in particular to influence the subsequent flow of the exhaust gas in the passage. In addition, a primary structure of this type may also represent a preparatory measure for the subsequent formation of (other or further) microstructures, for example slots, at which subregions of the metal foil are subsequently deformed so as to produce guide surfaces or the like.

As explained, the metal foil section is transferred by a profiled roller of the second tool. In other words, the second tool pulls the metal foil section through the first tool. Although it is also possible for apparatuses for clamping and/or guiding the metal foil section to be provided upstream of the first tool and/or between the first tool and the second tool, the advance of the metal foil section at the desired velocity or cycle rate is determined by the profiled roller.

In addition to the shaping, i.e. the production of a secondary structure, the profiled roller also has a transporting function for the metal foil section. Engagement of the profiled roller in the secondary structure of the metal foil section allows a force to be introduced parallel to the direction of advance of the metal foil section, with the rotational speed of the profiled roller determining the speed of advance of the metal foil section.

After the primary structure and the secondary structure (as well as any further structures) have been formed, the spatial position of these structures which are superimposed on one another is then recorded. In this step, it is preferable to in each case record reference points of the primary structure and the secondary structure and to evaluate the position of the reference points with respect to one another. It is possible for their position with respect to one another to be recorded in one or more planes (parallel, perpendicular and/or oblique with respect to the surface of the smooth metal foil section). In particular center points and/or center lines of the primary structure are recommended as reference points for the primary structure. By way of example, the extremities of the secondary structure, such as for example the corrugation peaks or corrugation valleys in the case of a corrugated structure, are recommended as reference points for the secondary structure.

After the spatial position of the primary structure and the secondary structure has been determined, their spatial position is evaluated. In this context, it is possible to predetermine different tolerance ranges or limit values, which differentiate an acceptable position (correct position) and an incorrect position from one another. If the result is that an incorrect position is present, at least one operating parameter of the at least one profiled roller is then altered. A suitable operating parameter is in particular the rotational speed of the profiled roller, although under certain circumstances it is also possible to carry out adaptations by varying the position of the profiled roller with respect to other components of the second tool, in particular a further profiled roller. Adaptation of this nature leads to the shaping profile of the profiled roller being realigned with respect to the distance to the first tool, thereby altering the position of the secondary structure in the metal foil section relative to the primary structure. This brings about accurate alignment of primary structure and secondary structure. The process proposed here allows highly dynamic control of the process for producing metal foils of this type with structures which are superimposed on one another, in which it is possible to automatically react quickly to material inhomogeneities, external disruptions or the like.

Furthermore, it is proposed that the at least one profiled roller is operated at an angular velocity which is altered. The profiled rollers used to produce the secondary structure have hitherto been operated at a constant angular velocity, with one revolution of the profiled roller if appropriate being divided into a multiplicity of rotation angle sections or increments and rotation continuing by a constant number of increments at predetermined time intervals. The present invention now departs from this procedure. If an incorrect position is detected, a correction is achieved by virtue of either continuing to rotate for a selected, constant number of increments but in an altered time interval and/or by the number of increments being varied while maintaining a constant time interval. In view of the fact that control of this nature is only launched when an incorrect position is detected, phases during which a constant angular velocity is present may also occur during the process, so that under certain circumstances a relatively long period of time (for example 5 minutes) needs to be considered with regard to a varying angular velocity.

However, it is particularly advantageous if the step of determining the spatial position is carried out at least once per revolution of the at least one profiled roller. Therefore a check of the spatial position of primary structure and secondary structure is carried out at the latest after every revolution of the profiled roller. This has the advantage that the control system is highly dynamic and can also react quickly to faults, such as for example the occurrence of vibrations.

It is also preferable if the step of detecting the incorrect position and adapting the operating parameter is carried out at least once per revolution of the profiled roller. It is in this case possible for the adapting of the at least one operating parameter of the at least one profiled roller to be controlled in such a way that the incorrect position is corrected at the latest after one revolution, in particular if the step of determining the spatial position is carried out only after each revolution. However, for an even more dynamic control system, it is advantageous if these steps are carried out a number of times per revolution of the profiled roller in order for a correction to take place in less than one revolution of the profiled roller. In the latter case, these steps ((d) and (e)) are preferably carried out at least twice and in particular at least four times per revolution of the profiled roller.

If the position of the profiled roller with respect to other components can be altered as the operating parameter, the configuration of the secondary structure is altered. Therefore, for example, the shaping sections of the profiled rollers engage in one another to a greater extent and the secondary structure is thereby produced with a greater height. This leads to a higher demand for material per segment of secondary structure, so that in this way it is likewise possible to shift the position of the primary structure and secondary structure relative to one another. With a view to the production of a honeycomb body, this leads to the formation of passages with different passage cross sections, which may be advantageous in certain applications. However, to accurately influence the flow properties of the exhaust gas in the honeycomb body in this way, very accurate control of the position of the profiled rollers is required.

According to a preferred configuration of the process, the formation of the primary structure (step a)) includes the stamping of openings and the formation of the secondary structure (step c)) includes the shaping of corrugations into the metal foil section. The openings may be configured as slots, holes or the like. The corrugations are substantially characterized by corrugation peaks and corrugation valleys, with the openings being aligned with respect to these corrugation peaks and corrugation valleys. In this case, it is preferable for the spatial position of the openings and corrugations in the direction of advance and in a plane of the metal foil section to be determined and adapted. Although this is a preferred variant, it is in particular also possible for openings to be introduced into the metal foil section by a rotary stamping tool and/or a laser. In principle, it is also possible for a plurality of primary structures or openings to be introduced simultaneously, so that after step a) the metal foil section has a plurality of rows of primary structures or openings.

Furthermore, it is proposed that an incorrect position involves a position shift from the primary structure to the secondary structure of greater than 0.3 mm. This produces a limit value used to distinguish a correct position from an incorrect position. The position shift is preferably considered in the direction of advance of the metal foil section. The reference points used for the primary structure and the secondary structure may be their center points or center lines. If the primary structure is formed by openings configured as slots, their center line should be parallel to the profile of the corrugation peaks or corrugation valleys. The maximum position shift which is still permissible from the primary structure to the secondary structure is preferably below an absolute value of 0.2 mm, in particular below 0.1 mm.

According to a further configuration of the process, the detection of an incorrect position is carried out by at least one optical sensor. The optical sensor is disposed downstream of the second tool (or a subsequent tool) and therefore observes the spatial position of the primary structure and secondary structure which have currently been formed. A recommended optical sensor is in particular a camera, the picture resolution (pixels) of which permits the determination of a position shift. These pixels can be used, for example, to determine the position shift and to effect a corresponding adjustment to the angular velocity of the at least one profiled roller.

A further aspect of the invention proposes an apparatus for producing structures which are superimposed on one another. The apparatus contains a first tool, which is able to produce openings in a metal foil section, and a second tool, which has a pair of shaping profiled rollers through which a metal foil section can be passed to produce corrugations. The pair of profiled rollers is able to effect an advance of the metal foil section through the first tool and the second tool. An appliance is provided for driving at least one profiled roller of the second tool. At least one optical sensor is connected downstream of the second tool as seen in a direction of advance, and at least one control unit is connected to the sensor and the appliance.

The apparatus is suitable in particular for carrying out a process which has been described in accordance with the invention.

In the apparatus described here, the first tool is preferably a stamping machine which removes subregions of the metal foil section. The second tool is preferably a corrugation rolling machine. Electric motors or servomotors may be advantageous as an appliance for driving at least one profiled roller. It is preferable for the at least one profiled roller to be driven with a frequency of greater than 6 Hz [1/second], in particular greater than 8 Hz or even 12 Hz. The at least one optical sensor preferably contains a camera. The at least one control unit evaluates the data from the at least one optical sensor and determines a spatial position of the primary structure and the secondary structure. Moreover, the control unit detects an incorrect position and then adapts an operating parameter of the appliance used to drive the at least one profiled roller. The control unit may included an image recognition device, data processing programs, memory elements and the like.

Preference is given to an apparatus in which the at least one sensor is configured in such a way that it has a variable detection field. This is to be understood in particular as meaning that the detection field can be positioned variably with respect to the metal foil section. This preferably ensures a movement of the detection field in the direction of advance or perpendicular to the direction of advance, it being possible for this movement to be realized by translational movements and/or by pivoting of the sensor. It is in this way also possible to record major position shifts (as may occur for example when starting the production process or during a material change). Moreover, it is possible to use a single sensor to record the reference points for the primary structure and the secondary structure at various regions of the metal foil section. It is in this way possible to keep the technical outlay involved in determining the spatial position of primary structure and secondary structure at a low level.

Furthermore, it is proposed that the at least one sensor is assigned a measuring roller which positions a metal foil section with respect to the at least one sensor. The measuring roller, which does not itself effect any permanent deformation of the structures, but rather is merely responsible for accurately guiding the metal foil section, produces, for example, an accurate alignment of the secondary structure with respect to the sensor. The measuring roller may in this case be provided with a separate drive or a drive coupled to the appliance. The measuring roller and sensor are preferably located on opposite sides of the processed metal foil section and are in particular disposed aligned with one another.

According to a further configuration of the apparatus, an illumination device is provided, which partially irradiates at least one side of the metal foil section in the detection field of the sensor. By way of example, there may be an illumination device which is positioned on the remote side of the metal foil section and radiates through openings (opposite light) and/or an illumination device which is disposed on the same side of the metal foil section as the sensor, in order to at least partially illuminate the detection field which can be seen by the sensor (incident light).

The invention now also proposes a metal foil section which has been produced by a process according to the invention or using an apparatus according to the invention and which has a length of greater than 1 m, with a maximum position shift of 0.3 mm between the primary structure and the secondary structure. It is preferable for a maximum position shift of this type to be present over significantly greater lengths, for example over 100 m or 1,000 m. The process according to the invention and the apparatus according to the invention for the first time allow production of such accurate metal foils over such a length. Therefore, such accurate metal foils can be provided even in series production, ensuring a high yield of material at a high production rate.

In this context, it is particularly preferable for the metal foil section to have a thickness in the range from 30 μm (0.03 mm) to 150 μm (0.15 mm) and a secondary structure with a ratio of width to height of less than 2.0, in particular even less than 1.5. Therefore, it has proven appropriate for the apparatus and/or the process to be used for deformation of very thin, filigree structures. The width/height ratio indicates that a relatively considerable deformation of the metal foil section is realized, with in particular the regions of the corrugation peaks and corrugation valleys being very small, and therefore accurate alignment of the primary structure and the secondary structure in the manner described above being advantageous.

It is very particularly preferable to construct a honeycomb body using at least one metal foil section of this type. In particular in the case of honeycomb bodies of helical construction, metal foil sections of a great length have to be processed, so that in particular in this case it is appropriate to use metal foil sections of this type. The thickness indicated for the metal foil section allows the provision of a large surface area within a small volume of the honeycomb body, and the width/height ratio is responsible for slender passages which ensure good mass transfer of the flowing exhaust gas toward the (coated) walls.

Other features which are considered as characteristic for the invention are set forth in the appended claims.

Although the invention is illustrated and described herein as embodied in a controlled metal foil production process, apparatus for performing the production process, and metal foil, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 diagrammatically depicts a first variant embodiment of an apparatus according to the invention;

FIG. 2 is a diagrammatic, perspective view of a metal foil section after various treatment processes;

FIG. 3 is a diagrammatic, plan view depicting the metal foil section with a correct position and an incorrect position of primary structure and secondary structure;

FIG. 4 is a diagrammatic, perspective view of a positioning of a sensor with respect to a metal foil section;

FIG. 5 is a graph depicting a position shift of the metal foil section produced with and without control;

FIG. 6 is a diagrammatic, perspective view of a honeycomb body; and

FIG. 7 is a diagrammatic, perspective detailed end view of the honeycomb body from FIG. 6.

### DESCRIPTION OF THE PREFERRED EMBODIMENTS

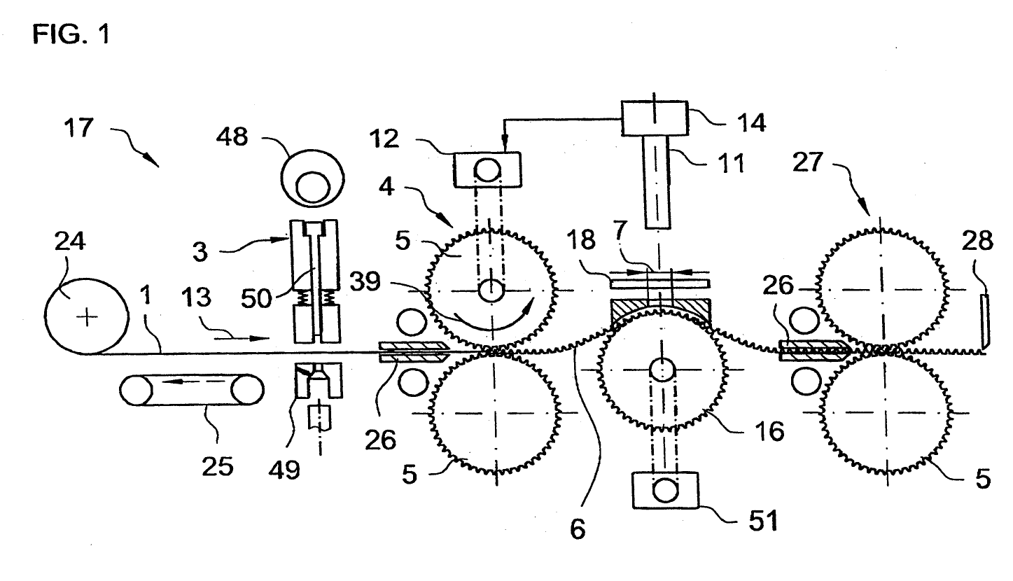

Referring now to the figures of the drawing in detail and first, particularly, to FIG. 1 thereof, there is shown diagrammatically a process for producing a multiply structured metal foil section 1. The following description is substantially based on a direction of advance 13, with the metal foil section 1 being unwound from a coil 24 and then passing through a first tool 3 and a second tool 4 before being examined by a sensor 11 and a measuring roller 16 and finally being fed to a third tool 27. The shaping of the metal foil section 1 is then concluded, so that the desired metal foil section 1 can finally be severed by a separation apparatus 28.

The coil 24 is a type of store for metal foil which is wound up helically. The coil 24 is generally driven and has a compensation element, for example what is known as a non-illustrated dancer, which compensates for fluctuations in the rate of advance of the metal foil section 1, connected downstream of it. Thereafter, the metal foil section 1 is passed via a foil brake 25, which ensures sufficient tensioning by the point of the advancing drive of the metal foil section 1. The foil brake 25 is preferably a type of felt belt, which is if appropriate moves counter to the direction of advance 13. To ensure that the metal foil section 1 bears reliably against the foil brake 25, the latter may be realized by a non-illustrated permanent magnet. Under certain circumstances, it may be advantageous for the supply of the metal foil section 1 to the first tool 3 to be controlled by the foil brake 25 likewise as a function of the produced position of a primary structure and a secondary structure, which can be effected separately and/or in addition to the control by the profiled roller 5.

The second tool 4 is configured with a pair of profiled rollers 5 rotating with a predetermined rotation angle 39 or a predetermined rotational speed. For this purpose, at least one of the shaping profiled rollers 5 is configured with an appliance 12 as its drive. The appliance 12 is also responsible for transporting the metal foil section 1 from the foil brake 25 to the first tool 3. A foil guide 26, which is responsible, for example, for perpendicular feeding of the metal foil section 1 as far as the profiled rollers 5, is provided between the first tool 3 and the second tool 4.

The first tool 3 is preferably a stamping machine working on the reciprocating motion principle, the reciprocating motion of a plunger 50 being effected by an eccentric 48. The stamping machine is able, for example, to introduce slots with dimensions of 2.5×0.8 mm into the smooth metal foil section 1. The material which is stamped out is removed by a suction extractor 49 located opposite.

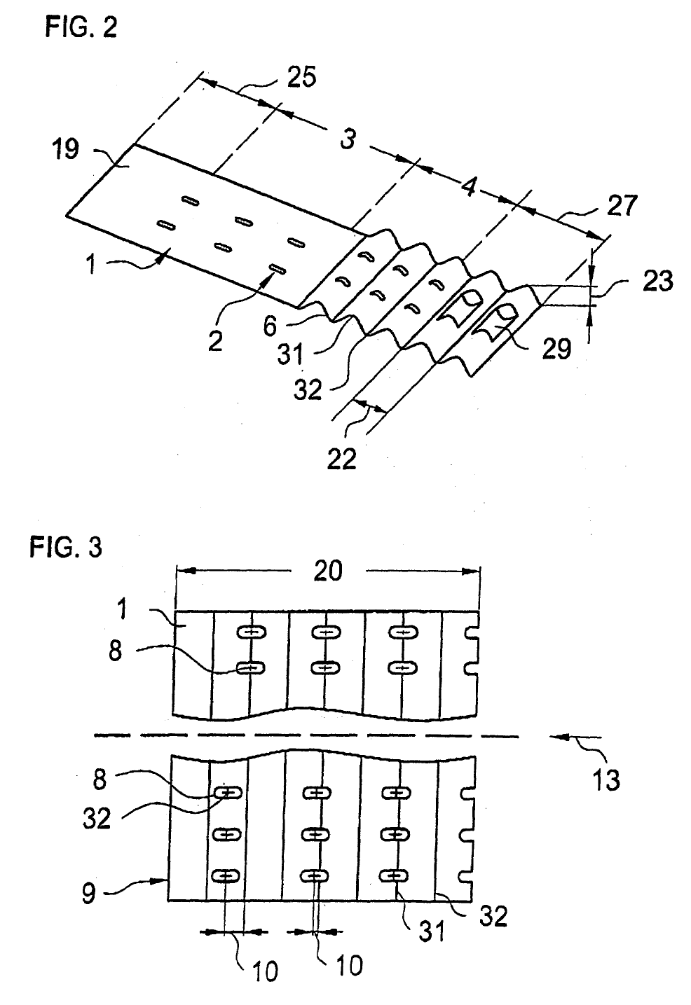

After the metal foil section 1 has then been provided with a primary structure 2 (see FIG. 2) by the first tool 3 and with the secondary structure 6 by the second tool 4, it is fed to a configuration having an optical sensor 11 which determines a spatial position of the primary structure and the secondary structure in a subregion 7 of the metal foil section 1. The sensor 11 is assigned a measuring roller 16 on the opposite side of the metal foil section 1, which measuring roller 16 is itself driven, a drive 51 preferably being connected via a coupling to the appliance 12 used to drive the profiled roller 5, for example via a non-illustrated belt. Moreover, an illumination device 18 is positioned on the side of the sensor 11 for at least partially lighting up a subregion 7 (incident light).

The image generated by the optical sensor 11 is processed in a control unit 14, which for example recognizes an incorrect position. If it recognizes an incorrect position, the control unit 14 adapts at least one operating parameter of the profiled roller 5 of the second tool 4, for example by influencing the driving appliance 12 and altering the angular velocity.

After it has left the appliance for determining the spatial position of the primary structure and the secondary structure, the metal foil section 1 is fed via the further foil guide 26 to the third tool 27, which likewise contains a pair of profiled rollers 5. The third tool 27 introduces a tertiary structure 29 (see FIG. 2) into the metal foil section 1 before the metal foil section 1 is cut to the desired length by the separation apparatus 28. The process illustrated here can be used to introduce particularly complex structures into a metal foil section while at the same time ensuring a high degree of accuracy over a prolonged period of time during series production of metal foil sections of this type.

FIG. 2 diagrammatically depicts the metal foil section 1 as is present in different regions of the apparatus shown in FIG. 1. From left to right in FIG. 2, it is possible to recognize first of all a smooth region, as is present for example in the region of the foil brake 25. The metal foil section 1 is then provided with the primary structure 2, in this case slots, in the region of the first tool 3. Thereafter, as illustrated further to the right, the secondary structure 6 is introduced in the region of the second tool 4; in the variant embodiment illustrated here, the primary structure 2 is disposed on each corrugation peak 31. The secondary structure 6 is produced with a width 22, which describes the distance between two adjacent corrugation peaks 31 or corrugation valleys 32, and a predetermined height 23, the height 23 describing the distance between a corrugation peak 31 and a corrugation valley 32. After the metal foil section 1 has left the second tool 4, the tertiary structure 29 is formed in the region of the third tool 27; in the variant embodiment illustrated, this involves a region of the metal foil section 1 between two adjacent primary structures 2 being pressed in. In this way, what is known as a microstructure is formed, which is subsequently to constitute a guide surface, projecting into a passage, for an exhaust-gas stream.

FIG. 3 illustrates the metal foil section 1 in plan view of a predetermined length 20. The upper part of FIG. 3 reveals an accurate alignment of the openings 8 with respect to the corrugation peaks 31. In the lower part of FIG. 3, it can be seen that the openings 8 are not accurately aligned with respect to the corrugation 9. A center 32 of the opening 8 has a position shift 10 with respect to the corrugation peak 31. The lower part of FIG. 3 also illustrates that the position shift 10 is becoming smaller from left to right, since the control has detected the incorrect position and adapted an operating parameter of the profiled roller. In this way, a correct position is achieved again after just a few corrugation peaks 31 or corrugation valleys 32.

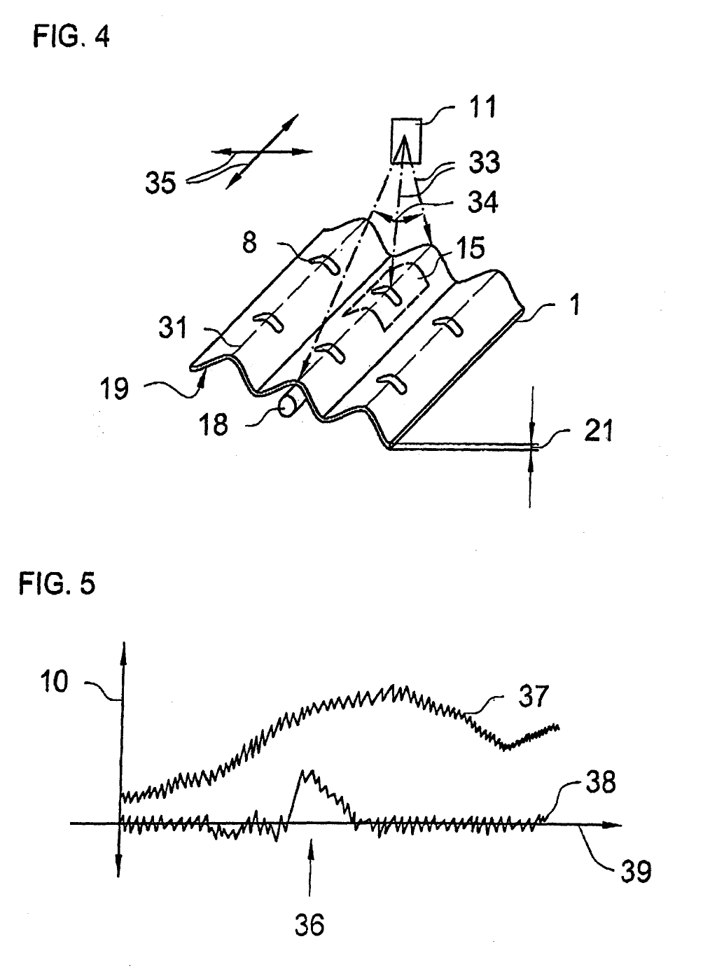

FIG. 4 diagrammatically depicts the positioning of the optical sensor 11 with respect to the metal foil section 1, which is formed with a predetermined thickness 21. As indicated diagrammatically here, the optical sensor 11 has a viewing direction 33 which describes its detection field 15. To scan different subregions of the metal foil section 1, it is possible to vary the detection field 15 with respect to the metal foil section 1. This is possible by the sensor 11 having a pivot angle 34 for pivoting a viewing direction 33 and by virtue of the fact that the sensor 11 can be moved in different directions of movement 35 relative to the metal foil section 1. In the variant embodiment illustrated, the illumination device 18, by which the opening 8 can be detected in opposing light, are provided on an opposite side 19 of the metal foil section 1 from the sensor 11. It is preferable for a reference point determination to be carried out by the sensor 11 in such a way that the position of the opening 8 is detected in opposing light in a first subsection of the detection field 15, while the position of the corrugation peak 31 is detected by incident light in another subregion of the detection field 15.

FIG. 5 diagrammatically depicts the position shift 10 over the rotation angle 39 of the shaping and transporting profiled roller 5. A first curve 37 illustrates the position shift 10 as was usually established in processes known hitherto as a result of position tolerances, material inhomogeneities, etc. The first curve 37 of this type, as also occurs from time to time in known apparatus, is characterized in particular by periodic fluctuations which are attributable in particular to tolerances in the region of the second tool and recur with the revolutions of the profiled rollers. In the second, lower curve 38, the position shift 10 varies to only a very small extent about the abscissa (corresponding to a position shift of 0 mm). The curve 38 can be moved even closer to the abscissa if the control system is made even more dynamic. By way of example, an external fault 36 (e.g. excited vibrations) has been applied here during production. As can be seen, a relatively major position shift 10 occurs initially, but this has been compensated for again after just a short time or after a short rotational movement of the profiled roller.

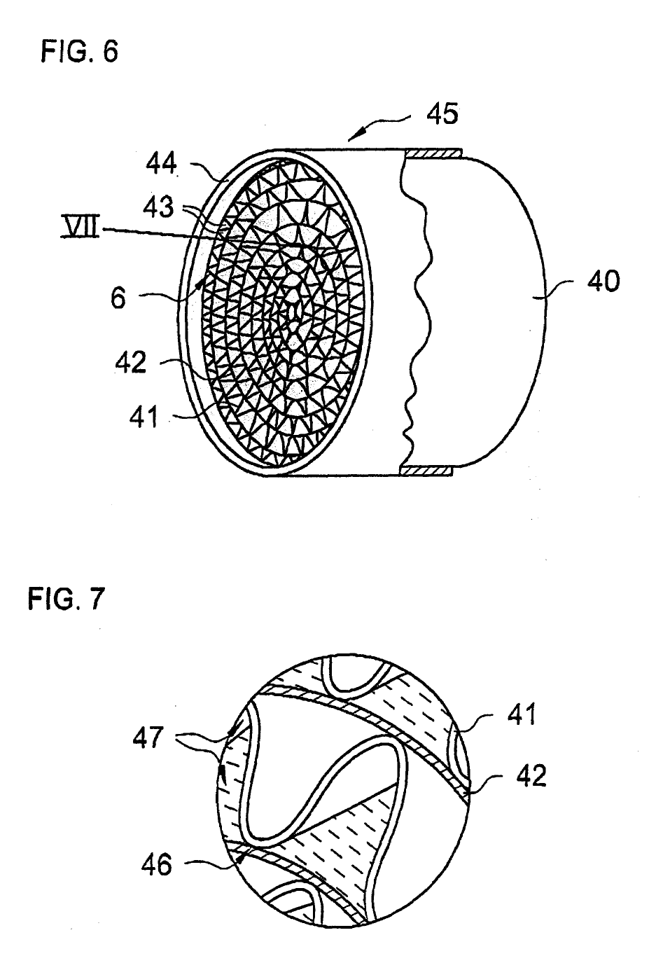

The preferred use of metal foil sections 1 which have been produced by the process according to the invention and/or using the apparatus according to the invention is for exhaust-gas treatment units 45 for use for purifying exhaust gases from mobile or stationary internal combustion engines. An example of the exhaust-gas treatment unit 45 of this type is illustrated in FIG. 6. The exhaust-gas treatment unit 45 contains a housing 44 in which a honeycomb body 40 is provided. In the variant embodiment shown, the honeycomb body 40 is constructed with a corrugated layer 41 and a smooth layer 42, which have been wound up helically. The corrugated layer 41 has structures which are superimposed on one another; the secondary structure 6, i.e. the corrugation shape, can be seen in this end-side view. The corrugation shape forms passages 43 through which the exhaust gas can enter inner regions of the honeycomb body 40. A detail (denoted by VII) of the honeycomb body 40 is illustrated in FIG. 7.

FIG. 7 shows an end-side view of the honeycomb body 40 in detail. The smooth layer 42 is realized using a filter material, while the corrugated layer 41 contains a metal foil section 1 of the type described above. The corrugated layer 41 and the smooth layer 42 form contact locations 46, which are used, for example, to provide connections produced by a joining technique and to delimit adjacent passages 43 from one another. At least some of the contact locations 46, the corrugated layer 41 and the smooth layer 42 are connected to one another, preferably by brazing. The walls which delimit the passages 43 and are formed by the smooth layer 42 and the corrugated layer 41 are provided with a coating 47 for catalytically converting the exhaust gases.

The invention described above is suitable in particular for the production of multiply superimposed structures in a metal foil section with a high degree of precision being achieved. This allows considerable cost savings to be made with regard to the production of metal foils of this type and also allows a considerable increase in efficiency and long-term durability of honeycomb bodies constructed using metal foils of this type to be achieved.

1. A process for producing structures being superimposed on one another in a metal foil section, which comprises the steps of:
a) producing a primary structure in the metal foil section using a first tool;
b) transferring the metal foil section to a second tool, the second tool having at least one shaping profiled roller being responsible for transferring the metal foil section;
c) producing a secondary structure in the metal foil section using the second tool;
d) determining a spatial position of the primary structure and the secondary structure in at least one subregion of the metal foil section; and
e) detecting an incorrect position and adapting an operating parameter of the at least one shaping profiled roller.

2. The process according to claim 1, which further comprises operating the at least one shaping profiled roller at an angular velocity being altered in the step e).

3. The process according to claim 1, which further comprises carrying out at least the step d) at least once per revolution of the at least one shaping profiled roller.

4. The process according to claim 1, which further comprises carrying out the step e) at least once per revolution of the shaping profiled roller.

5. The process according to claim 1, which further comprises performing the step a) by stamping openings and the step c) by shaping of corrugations into the metal foil section.

6. The process according to claim 1, wherein the incorrect position involves a position shift of the primary structure from the secondary structure of greater than 0.3 mm.

7. The process according to claim 1, which further comprises carrying out a detection of the incorrect position using at least one optical sensor.

8. An apparatus for producing structures being superimposed on one another, the apparatus comprising:
a first tool able to produce openings in a metal foil section;
a second tool having a pair of shaping profiled rollers through which the metal foil section can be passed to produce corrugations, said pair of shaping profiled rollers being able to effect an advance of the metal foil section through said first tool and said second tool;
an appliance for driving at least one of said shaping profiled rollers of said second tool;
at least one optical sensor disposed downstream of said second tool as seen in a direction of advance; and
at least one control unit connected to said optical sensor and said appliance.

9. The apparatus according to claim 8, wherein said at least one optical sensor has a variable detection field.

10. The apparatus according to claim 8, further comprising a measuring roller, said at least one optical sensor is assigned said measuring roller for positioning the metal foil section with respect to said at least one optical sensor.

11. The apparatus according to claim 9, further comprising an illumination device for radiating onto at least part of one side of the metal foil section in the variable detection field of said at least one optical sensor.

12. A metal foil section, comprising:
a body having a primary structure and a secondary structure formed therein, said body having a length of greater than 1.0 m, with a maximum position shift of 0.3 mm being present between said primary structure and said secondary structure.

13. The metal foil section according to claim 12, wherein said body has a thickness in a range from 30 μm to 150 μm and said secondary structure has a ratio of width to height of less than 2.0.

14. A honeycomb body, comprising:
at least one metal foil section having a primary structure and a secondary structure, said at least one metal foil section having a length of greater than 1.0 m, with a maximum position shift of 0.3 mm being present between said primary structure and said secondary structure.
